(19) United States
(12) Patent Application Publication
(10) Pub. No.: US 2008/0121583 A1
(43) Pub. Date: May 29, 2008

(54) Portable Universal Flow Filter

(76) Inventor: John E. Nohren, St. Petersburg, FL (US)

Correspondence Address: NIXON & VANDERHYE, PC, 901 NORTH GLEBE ROAD, 11TH FLOOR, ARLINGTON, VA, 22203, US

(21) Appl. No.: 11/765,137

(22) Filed: Jun. 19, 2007

Related U.S. Application Data
(60) Provisional application No. 60/814,557, filed on Jun. 19, 2006.

(51) Int. Cl. B01D 29/88

(52) U.S. Cl. 210/466

(57) ABSTRACT

A dual flow filter provides meaningful flow through the base of a monolithic carbon composite filter, creating axial flow, while concurrently providing radial flow through the side walls of the monolithic carbon composite filter element. The filter provides consumers with a more rapidly flowing product offering less pressure drop, i.e., resistance to flow, than other portable filters that have been offered to the consumer, while enhancing the simplicity, utility and esthetics of the product.

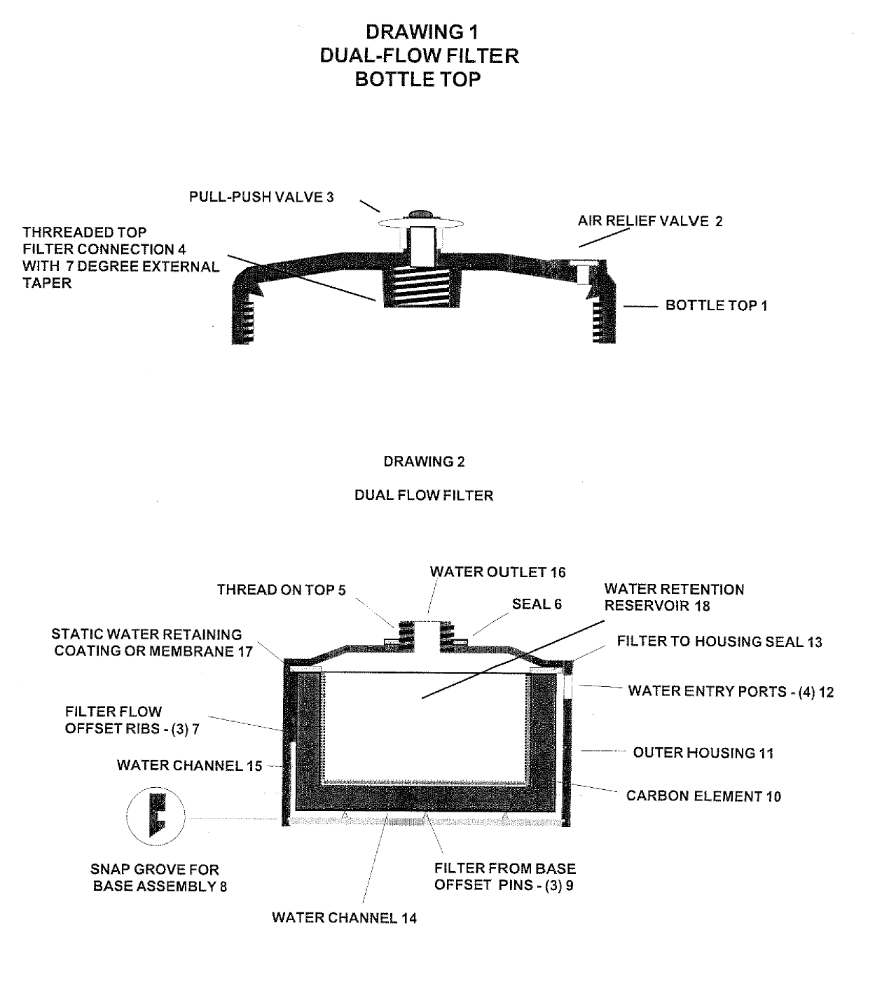

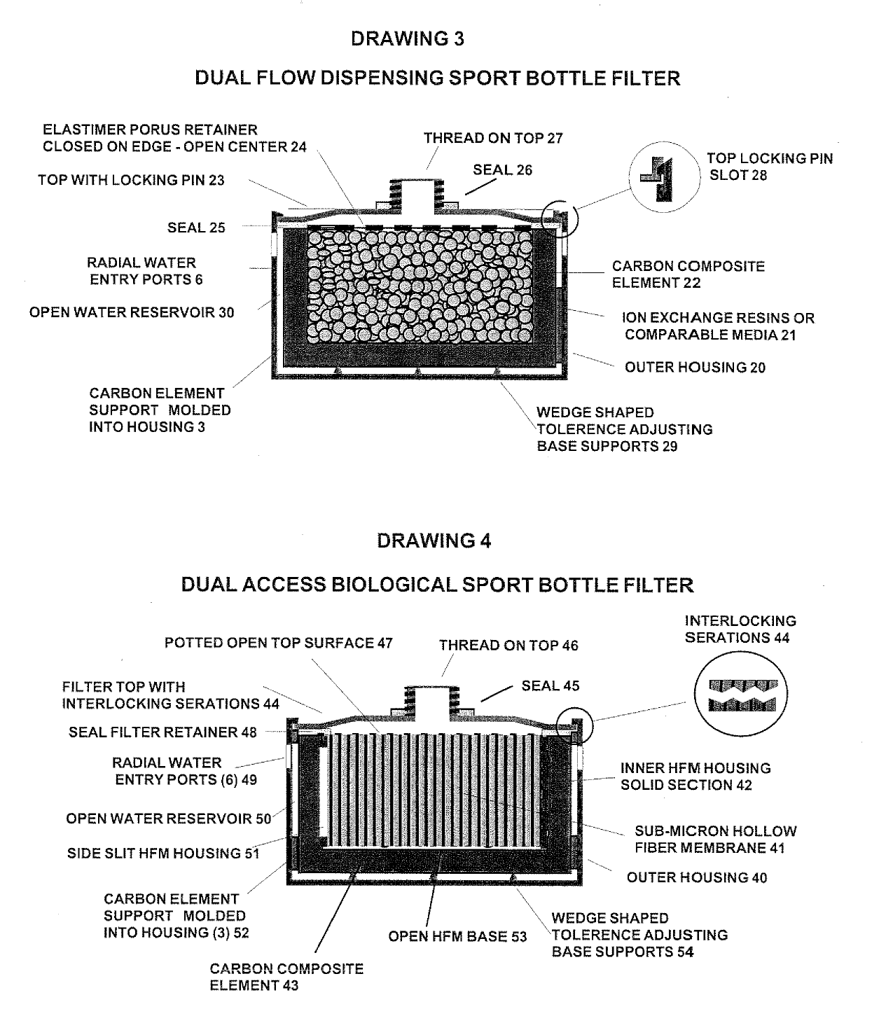

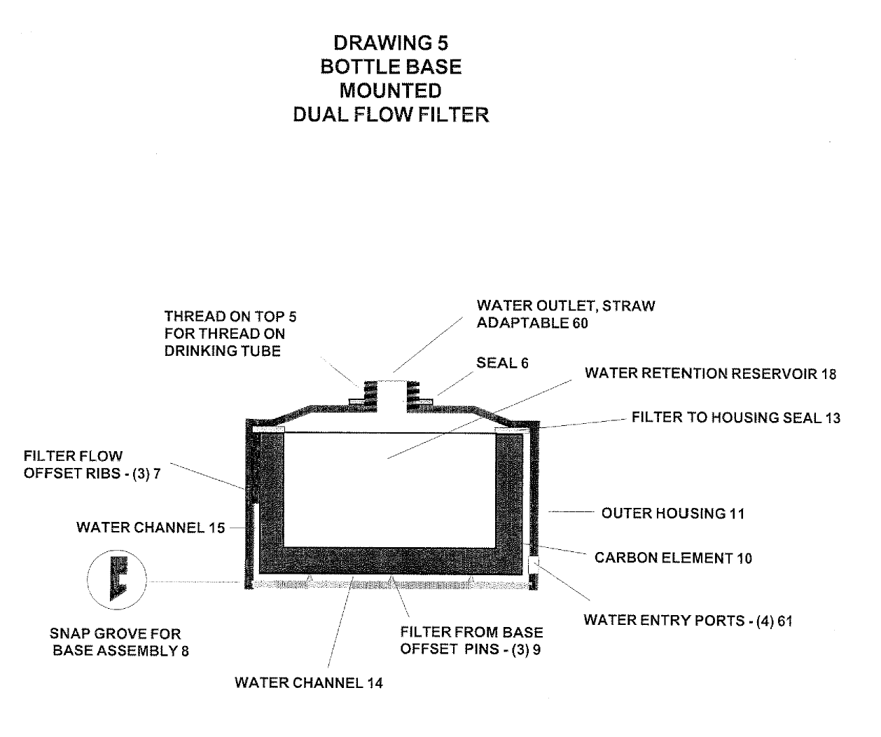

### CROSS-REFERENCES TO RELATED APPLICATIONS

This application claims the benefit of U.S. Provisional Patent Application Ser. No. 60/814,557, filed Jun. 19, 2006, the entire content of which is herein incorporated by reference.

### STATEMENT REGARDING FEDERALLY SPONSORED RESEARCH OR DEVELOPMENT

(Not Applicable)

### BACKGROUND AND SUMMARY OF THE INVENTION

The purpose of this invention is to provide consumers with a more rapidly flowing filter offering less pressure drop; i.e., resistance to flow, than other portable filters that have been offered to the consumer while enhancing the simplicity, utility and esthetics. These have been the major reasons for the lack of success in the past for portable filter bottles. In contrast to the small 12-16 ounce bottled water bottles that allow the water to stream out unrestricted with all the water in the bottle available for drinking. The available portable filtration products in the past have either been carbon block filters with a hollow central core, the base of which is either blocked by a plate and relief valve extending through the base, or simply closed off at the base, designed only for the radial flow of the water through the sides of the filter. Conversely, granular activated carbon filters have been used but are adaptable only to use in an axial flow configuration. In the case of radial flow designed filters; the length of the filter is maximized for radial surface area. The hollow center core is narrow, and/or a relatively small exit port is provided, generally of about ¼ inch, or less, and acts as a flow restrictor. By increasing the overall diameter of the filter, making the base of the filter large enough and available for filtration, it is practical to shorten the filters length without reducing performance by making all external surfaces of the filter designed and available for filtration. Flow is enhanced as a reservoir is created within the large open filter center, and minimal resistance to flow can be created by providing unrestricted access to a larger water exit port. Filters of this type may also be designed to minimize the water remaining in the bottle, not available for removal by the filter. Hence, the purpose of this invention is to enhance flow with reduced back pressure which is accomplished by creating a filter utilizing both axial and radial flow characteristics, combined with an outer housing which directs the water to all external filter surfaces. The housing being designed to also permit the maximum amount of water to be removed efficiently from the bottle without the intrusion of air.

A more rapid and easy flow is accomplished by incorporating axial as well as radial flow through the filter body. In addition by creating a large central void within the filter, acting as a reservoir, with the capability of retaining water within the reservoir in anticipation of the next drinking cycle. These features represent a unique departure from the norm providing the flow approximating a standard 12-16 ounce bottle of Bottled Water. Thus, answering the consumers demand for a fast and easy flowing filter bottle.

This type of filter preferably is mechanically and cooperatively connected to the bottle top forming a single assembly. The filter may also be designed to attach to the top of the bottle neck by means of a supporting flange and secured in place by the bottle top with which it operates cooperatively. For maximum convenience and efficiency the filter is mechanically fastened to the valved bottle top eliminating the need to handle the filter and bottle top separately when the bottle is opened and refilled. The third option is to place the filter on a tube or straw suspended to the base of the bottle permitting drinking without the need to invert the bottle.

The goal of the inventions disclosed in this application are to make a Water Filter Bottle as user friendly as a bottle of Bottled Water, yet offering far greater utility and a large economic advantage delivering fresh clean good tasting water to the user.

There are two basic concepts with several options flowing from each. The first is a carbon composite filter with an exposed base the inner surface of which is at least 10% or more of the totally exposed inner wall area. The filter is contained within a housing with water entry ports positioned so that even with water contained within the bottle that only covers ⅓rd of the filter, the entire housing is filled with water and the base of the carbon filter still functions as a filtration medium. This is accomplished by containing the filter within the outer housing, offsetting the filter from the housing to provide unobstructed water passage to all vertical and lateral surfaces. The base of the filter is also offset in a manner that permits the water to flow from the sides to the base with the pressure required to permeate the base the same as permeates the side walls. Thus, we have created a Dual Flow Filter.

To further enhance this invention, the filter may be coated on the interior with highly porous Teflon or similar coating, sprayed on; or in the form of an inset possessing a negative angle of wetting which the water does not penetrate flowing back into the bottle, when static, under the force of gravity alone. This is highly advantageous as it leaves a large reservoir of water to flow out unimpeded to the user on demand. The coating does not impede the flow of water across the filter into the center under normal operating pressure of 1-2 psig.

An additional enhancement is the incorporation of a domed top to the filter that serves several purposes as will be seen later. However, in the basic application at hand it permits a larger storage of water in preparation for the next drinking cycle. The domed contour of the filter coincides with the surface curvature and shape of the underside of the bottle top containing a valve to which it is preferably mounted. This feature combined with the water access ports being positioned near the top of the side of the outer housing leave little water that cannot be removed from the bottle when mounted to the top.

The filter is preferably threaded into a mating receptacle in the cap. This permits a much larger diameter opening than is commonly found, and also a means to permit the water to flow freely without mechanical constriction through the water delivery orifice. In one preferred top design a plastic tube of some 5/16th to ½″ is used, and closed off by any one of a variety of means. A larger diameter pull-push style valve may be used. The closure can also be effected by nesting the open tube end within a closure housing that is pivoted clear of the tube for drinking purposes, but may be pivoted up and over the tube and forces the tube into a nest within the top. The actual closure is accomplished by a boss either within the pivoting closure or as a component of the top tube nest shaped in the manner of the driving element in a peristaltic pump. Thus, effecting a closure without squeezing the collapsed tube side edges.

As a result of the relatively large open center, the carbon composite element may also be used to house flavor impregnated porous plastic beads or cylindrical elements to elute a flavor to the water passing through. A variety of secondary medias may also be incorporated for the purpose of VOC removal, Arsenic removal, Nitrate removal, or to add minerals to the water.

Due to the construction and water flow it can also be desirable for those seeking the greatest availability of water for hydration to incorporate magnets arranged on opposite sides of the carbon element, preferable using four opposed magnets; with two having South facing South polarity, and the second set with North facing North polarity for the purpose of de-clustering the filtered water.

A further application that the subject design lends itself to is the inclusion of hollow fiber membranes (HFM) contained within their own housing open at the bottom with slits or holes in the housing side also providing radial access to the HFM's. By creating dual flow both the availability of water as well as pressure required to pass the water through the membrane is enhanced. The HFM is used to eliminate both protozoa and bacteria to recommended EPA limits. For this purpose specially manufactured Tory or NOK membranes are used, which have been assembled to the specialized HFM dual flow housings, which are a component of this invention. Typically the water is delivered through the HFM at a pressure drop of 2-11 psi, with a flow rate of up to 30 ml/sec; preferable 2-5 psi with a flow exceeding 10 ml/sec.

### BRIEF DESCRIPTION OF THE DRAWINGS

Drawing 1: Shows a Sport bottle Top configured with a centrally mounted pull-push valve, an air-relief valve encapsulated within the top, and an internally threaded cylindrical mounting boss extending from the inner base directly below and communicating with the pull-push valve above. The external surface if the boss is tapered at a locking angle to provide an optional means of securing a filter rather than the use of the internal threaded section.

Drawing 2: shows a dual flow carbon composite filter in a housing designed to be threaded to the bottle top with water entry near the top of the housing.

Drawing 3: shows a dual flow carbon composite filter which also contains an ion exchange resin, or any of a number of alternate treatment medias as well as porous beads which may be encapsulating and release a flavoring or other such element desired to be released into the filtered water prior to drinking. The internal loose components are retained within the filter body under the domed housing to permit a water reservoir-distribution area to be formed.

Drawing 4: shows a dual access biological filter with the contained carbon composite filter internally containing a sub-micron hollow fiber membrane with water access from the side as well as from the base of the assembly.

Drawing 5: Shows a filter as described in drawing 2, but with the water inlet ports positioned at the base of the filter housing adapting the filter to be attached to a tube or straw permitting the filter to be mounted at the base of the bottle thus permitting water to be removed without inverting the bottle.

### DETAILED DESCRIPTION OF PREFERRED EMBODIMENTS

Drawing 1: Shows the threaded bottle top 1, the recessed air relief valve 2 permitting air to return into the bottle to replace the displaced water and eliminate a pressure differential from within the bottle to the external atmosphere. The top has a centrally mounted water outlet valve 3, which is cooperatively connected with the internally threaded filter connecting boss 4. The external surface of the connecting boss 4 is tapered to secure by a friction fit an alternate filter such as produced by Innova Pure Water, Inc. with a mating surface design, approximately seven degrees. Typically, the cap is designed to mate with standard bottle threads from 63 mm, or more, to 53 mm, or less in neck diameter.

Drawing 2: Shows a Dual Flow Filter adaptable to Bottle Top 1 by means of the threaded hollow boss 5, which is sealed to Top 1 by the seal ring 6. The outer housing 11 is molded as a single component with threads 5, and four water entry ports 12. Molded into the housing 11 is also three filter offset ribs 7, the purpose of which is to center and support the carbon composite filter 10, while allowing adequate channels 15 for water to flow with the essentially same pressure around the entire periphery of the carbon composite filter. There is a snap grove 8, also molded within the housing, which mates with and locks the filter base 9 to the housing 11. The filter base 9 contains three elevating base offset pins to create a channel 14 for water flow permitting the water within the filter to have unimpeded access to the base of the carbon composite filter with minimal to no pressure drop from the water being forced through the side or peripheral walls of the carbon filter. The second purpose of the base offset pins in base 9 is to assure the filter 10, is firmly seated against the internal housing seal 13, and to compensate for accumulated tolerances. An optional but attractive feature of the design is the inclusion of a highly porous membrane or coating with a negative angle of wetting. This interior liner 17 serves the function of retaining the water within the retention reservoir 18, precluding the water from returning to the bottle under the force of gravity. This provides a material advantage, as water is available for essentially the first drink without pressurizing the bottle and literally allowing the user to gulp or “chug” water from the bottle. The filter outlet orifices are of a larger than normal diameter to facilitate flow and mate with larger top valve orifices.

Drawing 3: Represents a very similar filter modified internally to house any one of a variety of different elements as depicted by number 21. The internal media 21 could consist of ion exchange resins, GAC, KDF, or other media covering a variety of purposes for example the removal of nitrates and heavy metals; a polymer extraction media for the removal of arsenic or radioactive contamination. The internal media 21 can also consist of porous plastic elements filled with flavoring or vitamins or compounds, which have water solubility and may be controlled as to the rate of release. The housing 20 is similarly configured with the exception that the open top of the housing has a locking slot 28 molded in to mate with the separate top 23 containing threaded top 27 and seal 26. A single locking pin as shown in expanded view 28 locks into a slot in the housing 20 to eliminate the possibility of radial slippage when inserting or removing the filter from the top. Molded into the base housing are wedged shaped stand off and adjusting supports 29 providing a reservoir and access to the base of the carbon filter by the pressurized water.

One unique feature permitted by this dual flow design with a wide diameter, in this instance greater than the height, is to create a void for water flow 32, above the media. The media is retained within the walls of the carbon composite element by a porous retaining screen over the annulus 24, covering the internal media; the external radial edges being solid and forming the seal 25. As in Drawing 2, the monolithic carbon composite element 22, is offset by three evenly spaced ribs 31, molded into the internal side of the housing 20.

Drawing 4: This design is essentially identical to Drawing 3 with the exception that the monolithic carbon filter 43, contains a sub-micron hollow fiber membrane 42 of 0.1-0.3 micron pore size for the rejection of bacteria and protozoa. The hollow fiber membrane contains typically more than 80 in sq of surface area, has a pressure drop of from 2-10 psig, with the capability of withstanding as much pressure as may be applied by an individual; 30 psig, or more, in some instances. The hollow fiber membrane removes bacteria and protozoa through at least 6 logs, or 99.9999%, as verified by independent testing laboratories. The useful life is depending upon turbidity in the water, but with a turbidity level of 1 NTS, the filter will process approximately 80 gallons. The hollow fiber membrane component 41 is not an independently replaceable element, but is contained within its own housing 42, which is slid into place before the filter top 44 is attached forming a sealed unit. The hollow fiber membrane housing 40, contains side slits 51, covering the majority of the peripheral housing surface. Thus, as the housing 41 is completely open at the base, it is also open to the sides of the hollow fiber membrane elements. This provides for both radial and axial flow reducing the pressure required and providing improved access to the hollow fiber membrane bundle. As the top of the hollow fiber membrane bundle is potted 47, to the outer housing 40 and retained in position by the seal 48, it is not necessary to have a porous retainer over the hollow fiber membrane. The potting 47, while holding the fibers in place and forming a seal between fibers, does not obstruct the open ends of the fibers allowing for treated water flow. The equalization of water flow and force from the sides, radially, and from the base axially up through the filter and into the hollow fiber membrane housing enhance the applied pressure and resultant water flow. The void created by the design of the filter's top surface 44, creates a void for water flow again minimizing resistance while at the same time providing an area into which to evacuate air that may otherwise be trapped.

Drawing 5: This drawing shows an alternative filter design, identical to the filter of drawing 2, but modified for mounting to a tube or straw to permit the filter to be mounted at or close to the bottom of the container (bottle). The top 5, is designed to be attached to either a tube which would thread on in the same manner that the filter would be assembled to the bottle top. Alternatively the inner diameter of the threaded mounting boss 60 is sized to fit a ¼ inch diameter tube (straw) or such larger diameter as may be dictated. The water access ports 61 are positioned at the lower end of the filter housing 11, to permit the maximum removal of water from the container without refilling. As an alternative openings may be placed within the base plate 9. The side location of the water access ports 61 is deemed preferable as if the filter body is resting upon the base of the bottle greater resistance will be had literally “sucking” up upon the base of the bottle.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A dual flow filter providing meaningful flow through the base of a monolithic carbon composite filter, creating axial flow, while concurrently providing radial flow through the side walls of the monolithic carbon composite filter element.

2. A filter as described in claim 1 which contains an interior highly porous element or coating possessing a negative angle of wetting capable of retaining water within the hollow center of the filter body when the filter, within a typical water bottle, is static and in an up-right attitude, yet permits the ready passage of water with the application of pressure of 1-2 psig.

3. A filter as described in claim 1, the internal volume of which contains a second filtration media such as an ion exchange resin, or polymer composition employing ligands to remove unwanted containments such as arsenic and radio-active contaminants.

4. A filter as described in claim 1, the internal volume of which houses a sub-micron hollow fiber membrane bundle, which has both radial and axial pressurized filtered water access.

5. A filter as described in claim 1 which employs a dome configured top providing unrestricted axial water flow access from the entire open facial area of the filter elements to the exit opening.

6. A filter as described in claim 1 designed to be operatively connected to the bottle top with valve.

7. A filter as described in claim 1 which may be reconfigured to mount at the base of a water container connected to the top by a drinking tube or straw, with water entry from the side at the base of the filter housing or through the base of the filter housing. Such filter and bottle within which it is contained being designed to be used in an up-right attitude.

8. A filter as descried in claim 1 which contains a mechanical means for assembly to the top of a standard or special water container and designed to be used in an inverted attitude.

9. A filter housing designed to permit water to flow readily both axially and radially, with near equal pressure to all external exposed surfaces of the contained filter.

10. A filter housing as described in claim 9 acting as a shroud allowing water to enter through entry ports that may be positioned at either the top or base of the housing while distributing the water to all filter surfaces permitting maximum water removal from the container whether affixed at the bottle top, or positioned at the base of the bottle by means of a tube or straw.

11. A carbon composite filter typically with a diameter equal to or greater than the functional height of the filter element; but under any circumstance permitting both meaningful axial as well as radial flow through the carbon element body.
